(19) United States
(12) Patent Application Publication
(10) Pub. No.: US 2014/0141793 A1
(43) Pub. Date: May 22, 2014

(54) SYSTEM AND METHOD TO MANAGE QOS IN A BANDWIDTH-CONSTRAINED NETWORK (CELLULAR) BY SENDING TOWER-INITIATED POLICY CHANGES TO INDIVIDUAL PHONES

(71) Applicant: INTERNATIONAL BUSINESS MACHINES CORPORATION, Armonk, NY (US)

(72) Inventors: Adekunle Bello, Pflugerville, TX (US); Gregory J. Boss, Saginaw, MI (US); Pernell J. Dykes, Byron, MN (US); Rick A. Hamilton, II, Charlottesville, VA (US)

(73) Assignee: INTERNATIONAL BUSINESS MACHINES CORPORATION, Armonk, NY (US)

(21) Appl. No.: 13/680,830

(22) Filed: Nov. 19, 2012

(51) Int. Cl. H04W 72/04

(52) U.S. Cl. CPC H04W 72/0406
USPC 455/452.2

(57) ABSTRACT

A method, system and computer-usable medium are disclosed for preemptively managing bandwidth consumption in a wireless network environment. A wireless service provider monitors network activity to generate network bandwidth availability data. The network bandwidth availability data is processed with bandwidth consumption projection data to determine whether the wireless network is able to provide a first amount of bandwidth. If the wireless network is unable to provide the first amount of bandwidth, then it generates a bandwidth mitigation request, which it in turn provides to a mobile device. If an affirmative response is received from the mobile device, then it is provided a second amount of bandwidth, which is less than the first amount of bandwidth.

### BACKGROUND OF THE INVENTION

1. Field of the Invention

The present invention relates in general to the field of computers and similar technologies, and in particular to software utilized in this field. Still more particularly, it relates to a method, system and computer-usable medium for preemptively managing bandwidth consumption in a wireless network environment.

2. Description of the Related Art

The use of mobile devices such as “smart phones,” tablet computers, “netbook” computers, traditional laptops, and other hybrid devices has become popular in recent years. These devices, which are increasingly capable of generating and consuming significant amounts of data, have placed corresponding demands on wireless networks. However, these demands are not evenly distributed across all mobile device users. In fact, a recent study indicated that 1% of smart phone users consume 50% of all wireless bandwidth.

It is generally recognized that bandwidth capacity must be built to accommodate the highest peak demands, although that capacity may be oversized during non-peak times. For instance, a wireless network servicing a highway in a metropolitan area may be sized for very high bandwidth capacity in anticipation of many cars on the road. This capacity might be lightly used during most parts of the day, but users may still get frequent dropped calls or “congestion” errors for attempted data or voice activity during rush hour.

Build-out of new infrastructure comprises expense to the service provider, and thus represents a trade-off which between additional investment and decreased customer satisfaction. However, sizing a network often presents challenges, as today's wireless networks have no knowledge of future loads for data or voice traffic, other than empirical trends based on past bandwidth consumption during chronological windows or special events. Having such predictive information would permit better decisions on handling bandwidth-constrained periods.

### SUMMARY OF THE INVENTION

A method, system and computer-usable medium are disclosed for preemptively managing bandwidth consumption in a wireless network environment. In various embodiments, a wireless service provider monitors network activity to generate network bandwidth availability data. In these various embodiments, the network bandwidth availability data is processed with bandwidth consumption projection data to determine whether the wireless network is able to provide a first amount of bandwidth. If the wireless network is unable to provide the first amount of bandwidth, then it generates a bandwidth mitigation request, which it in turn provides to a mobile device. If an affirmative response is received from the mobile device, then it is provided a second amount of bandwidth, which is less than the first amount of bandwidth.

In various embodiments, the bandwidth consumption projection data is provided by the mobile device. In these embodiments, the bandwidth consumption projection data is generated from various data associated with past wireless communication sessions. In various embodiments, the compliance with the bandwidth mitigation request may be either discretionary or compulsory. Certain of these embodiments, the bandwidth mitigation request may comprise discretionary offers to the mobile device user. In certain embodiments, the bandwidth mitigation request may comprise compulsory changes of policy or modification of an application's behavior.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary client computer in which the present invention may be implemented;

FIG. 2 is a simplified block diagram of the operation of a wireless bandwidth Quality-of-Service (QoS) management system in a wireless network environment;

FIG. 3 is a generalized flowchart of preemptive wireless bandwidth management operations; and

FIG. 4 is a generalized flowchart of wireless bandwidth QoS management operations.

### DETAILED DESCRIPTION

A method, system and computer-usable medium are disclosed for preemptively managing bandwidth consumption in a wireless network environment. As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

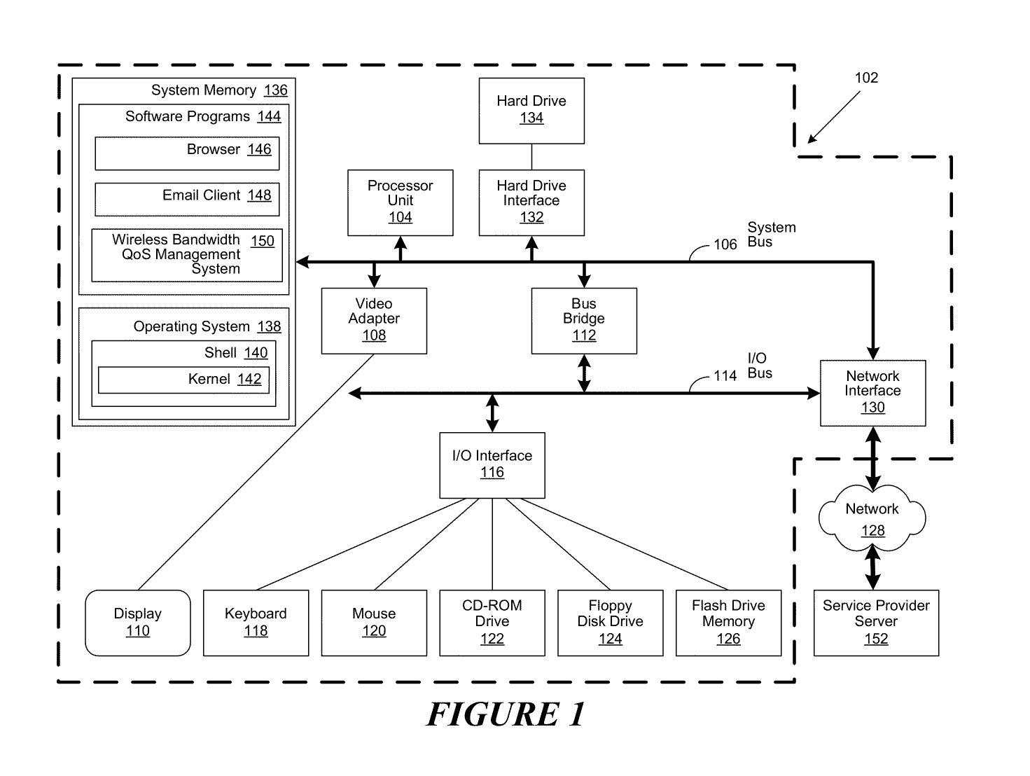

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management. Software programs 144 may include a browser 146 and email client 148. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. In various embodiments, software programs 144 may also include a wireless bandwidth Quality of Service (QoS) management system 150. In these and other embodiments, the wireless bandwidth QoS management system 150 includes code for implementing the processes described hereinbelow. In one embodiment, client computer 102 is able to download the wireless bandwidth QoS management system 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit, scope and intent of the present invention.

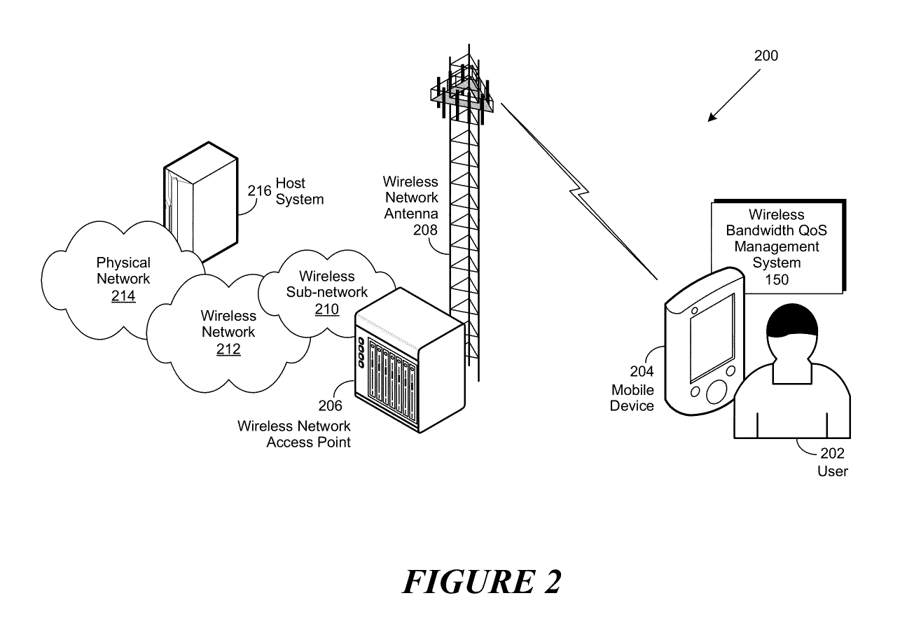

FIG. 2 is a simplified block diagram of the operation of a wireless bandwidth Quality-of-Service (QoS) management system implemented in accordance with an embodiment of the invention in a wireless network environment. In various embodiments, a mobile device 204 performs wireless data communications within a wireless network environment 200. In these and other embodiments, the mobile device 204 may comprise a wireless handset (e.g., a cell phone), a smart phone, a personal digital assistant (PDA), a portable computer, a tablet computer, a laptop computer, or any computing device operable to perform data communication operations.

The mobile device 204 may further accept data or other input from a user 202, including various parameter values for configuring its operation. The mobile device 204 may further execute one or more software or firmware applications, such as a wireless bandwidth QoS management system 150, in response to commands from a user 202 or a wireless network access point 206 (e.g., a base station). In certain embodiments, the mobile device 204 itself, or the wireless bandwidth QoS management system 150 may be programmed or configured over-the-air (OTA), for example from a wireless network access point 206.

In various embodiments, the wireless network 212 comprises a plurality of wireless sub-networks 210, such as wireless cells with corresponding coverage areas. In these embodiments, the mobile device 204 transmits and receives communication signals, which are communicated to and from the wireless network access point 206 by a wireless network antenna 206 (e.g., a cell tower). In turn, the wireless network access point 206 is coupled to the wireless sub-network 210, which is connected to the wireless network 212. As used herein, the terms “wireless network access point,” “base station,” “wireless tower,” “cell tower,” “network tower,” and “tower” all broadly refer to the general functionality provided by the combination of a wireless network antenna 206 and a wireless network access point 206. In various embodiments, the wireless network 212 is coupled to a physical network 214, such as the Internet. In these embodiments, the mobile device 202 has access to information on various host systems 216 via the wireless network 210 and the physical network 212.

In various embodiments, the wireless bandwidth QoS management system 150 is implemented on the mobile device 204 to provided anticipated bandwidth consumption requirements to a wireless service provider. In certain of the embodiments, the wireless bandwidth QoS management system 150 may be implemented as a software application or as firmware within the mobile device 204.

In these various embodiments, the preemptive knowledge referenced by the anticipated bandwidth consumption requirements assists the wireless service provider in managing wireless bandwidth QoS for predetermined mobile devices 204. For example, the initiation of a wireless data application creates step functions of demand. To further the example, video downloads, voice traffic, web surfing, and other wireless data applications either “peg” the wireless network 212 or they do not.

Those of skill in the art will recognize that some wireless data applications comprise periodic jobs (e.g., scheduled activities) that can be forecasted. Such applications may comprise “bursty” demands of wireless bandwidth, where demand may be zero at one moment and zero at some incremental moment in the future, but finite and non-zero at some later and predictable point in the future. Examples of such bandwidth demand include email replication (e.g., “check for email and retrieve any new messages every five minutes”) or social networking applications (“download any new Facebook status updates to my mobile device every 30 minutes”). While precise data about the demand interval may not be known, the fact that demand will exist at a certain time can be used, along with optional empirical information on expected needs.

As an example, a legacy wireless network 212 may be running at 98% capacity. As a result, the aforementioned periodic demand may cause the system capacity to be exceeded and thus result in an unexpected loss of service or reduction in QoS. However, if a wireless network 212, likewise running at 98% capacity, is forewarned that a spike in demand is forthcoming from the particular mobile device 204, then it can preemptively “trim” bandwidth to accommodate the spike. For example, for a predetermined amount of time (e.g., seconds, milliseconds, microseconds) before the impending spike, the service provider may preemptively:
uniformly reduce service provided to existing users 202;
reduce service provided to other users 202, based upon class of application (e.g., real-time media may be untouched, whereas web surfing, such as text and image retrieval, may be reduced);
ascertain whether certain classes of service have run ahead of the mobile device's 204 capacity and reduce those services (e.g., “four seconds of streamed video have been downloaded to a device within the past one second, thus this device can suffer a three second loss of service without user interruption.”).

In each of these scenarios, the service provider has balanced service such that overall user satisfaction is optimized by ensuring no loss of service to any one user 202.

It will likewise be appreciated that various users 202 may be concurrently performing different step function wireless data applications. For example, one user 202 may be streaming video, another streaming audio, yet another is retrieving text and video, etc., such that the combined users 202 use significant portions of the wireless network's 212 capacity. As a result, new requests for wireless bandwidth may experience a congestion event (i.e., a service failure or reduced service quality) in response.

Without future knowledge, only the running system utilization may be tracked, and the system has no “knowledge” whether the next demand fluctuation will be upward or downward. The system does not “know” whether a failure will occur or whether demand will be relieved. However, if the wireless service provider can anticipate potential bandwidth constraints, then standard arrival models can be applied, using techniques derived from queuing theory, to determine the likelihood of a new demand arrival. If the likelihood is high, then service can be preemptively reduced to the preexisting jobs.

In various embodiments, preemptive wireless bandwidth management operations are implemented by a user 202 initiating an action related to wirelessly communicating data with a mobile device 204. In certain of these embodiments, the user action may comprise an implicit data communication activity, such as the invocation of a voice call, or explicit data communication activities, such as provision or receipt of text, images, audio, video or executable code. In these and other embodiments, the wireless bandwidth QoS) management system 150 implemented on the mobile device 204 generates a bandwidth consumption projection, based upon attributes (e.g., voice, text, video, etc.) of the data communication activity and an estimate of how much data will be wirelessly communicated.

In various embodiments, the initiation of one data communication activity may indicate that multiple activities are forthcoming. As an example, a user 202 viewing one video or listening to one song may provide a historical indicator that multiple, distinct videos or songs will be consumed. As a result, bandwidth consumption projections can be made for similar forthcoming data communication activities. In one embodiment, the bandwidth consumption projection is performed by processing historical records of past call durations with a predetermined party, such as the user 202 of another mobile device 204 or a data content source, such as host system 216. For example, when a wireless call is initiated, the average historical call length, or some other statistical call length duration, may be assumed. To further the example, a call to one number (e.g., a spouse) may run two minutes on average, but a call to another number (e.g., a conference line) may run 30 minutes on average.

In another embodiment, data file attributes are provided to the wireless service provider. For example, a user 202 may request media content (e.g., song, video, etc.) of a known type and duration. These attributes are then provided to the wireless service provider when the media content is requested, downloaded or otherwise consumed. Alternatively, the user 202 of the mobile device 204 may send media content stored on the mobile device 204 to another user 202 of a mobile device 204. In this embodiment, an overall byte count for the content may be used as one of the attributes. Alternatively, a consumption model may be implemented to determine the anticipated amount of data per unit of time, multiplied by the length of the media, which is then provided to the wireless service provider as a consumption attribute, which in turn serves as the bandwidth consumption projection.

In yet another embodiment, the bandwidth consumption projection is performed by processing historical records of streaming media use. As an example, certain streaming media, such as an online “radio” station, has no definitive length. However, a bandwidth consumption projection can be determined, based upon the currently-measured streaming media throughput, and the average length of time that the user has historically consumed such media.

In still another embodiment, the bandwidth consumption projection is based upon the historical, average size of downloads from a predetermined site. In this embodiment, a light duty web site (e.g., one showing local movie listings) is differentiated from a heavy duty web site (e.g., a site for downloading software). For example, historical visits to a site to check on movie listings may not result in significant bandwidth consumption, while downloading software from another site would likely result in higher bandwidth consumption.

In one embodiment, the bandwidth consumption projection is based upon external factors. As an example, popular events (e.g., athletic, political, social, etc.) may result in congested wireless network traffic. By extension, the scope of such congestion may be locational (e.g., local, state, national or global) or temporal (e.g., time of day, day of week, holidays, etc.). Other external factors may include network type or other obtainable external information which can contribute to projecting expected call lengths and bandwidth consumption.

In another embodiment, the bandwidth consumption projection is based upon historical static traffic levels and consumption models that predict the likelihood of dynamic traffic levels. In this embodiment, static traffic levels refer to wireless traffic that typically occurs at predetermined, recurring time intervals (e.g., prior to users leaving for work or school) and during intervals that historically have lower traffic (e.g., when users are typically away from their homes). For example, such static traffic levels may be reflective of traffic that corresponds to wireless towers or infrastructure located in residential areas. Conversely, dynamic traffic levels refer to wireless traffic associated with towers or infrastructure that support higher temporary traffic and must scale based upon more clients of a transient nature (e.g., near highways or high traffic commercial enterprises such as shopping malls, etc.). Accordingly, the static and dynamic traffic levels can serve as a baseline model for expected traffic congestion models.

The bandwidth consumption projections are then provided to the wireless service provider for processing. In various embodiments, the bandwidth consumption projections are provided by a plurality of mobile devices 204. As an example, the wireless service provider may receive the following bandwidth consumption projections from a plurality of mobile devices 204 within the same cell coverage area:

User 1: anticipates 50 KB over the next 5 minutes with a maximum throughput of 2 Kbps

User 2: anticipates 2,050 KB over the next 2 minutes with a maximum throughput of 2 Mbps

User 3: anticipates 350 MB over the next 45 minutes with an average throughput of 700 Kbps, etc.

In various embodiments, each application (e.g., video, voice, etc.) implemented on a mobile device 204 provides its own bandwidth consumption projection, based upon typical application-specific bandwidth consumption characteristics. In certain embodiments, the wireless bandwidth QoS management system 150 aggregates the bandwidth consumption projections from various applications and provides the aggregated bandwidth consumption projection to the wireless service provider. The wireless server provider then uses the provided bandwidth consumption projections to adjust wireless bandwidth QoS appropriately for the mobile device 204.

Skilled practitioners of the art will be aware that service in legacy wireless systems typically fails when capacity is exhausted. However, from the foregoing, it will be appreciated that the present invention allows for the prediction of bandwidth consumption circumstances which could, if not addressed, result in failure. As a result, wireless service optimization may be accomplished using a variety of preemptive QoS management operations, including:
identifying classes of service may be preemptively throttled-back;
determining that a predetermined user 202 has been “overserved” and can withstand a short interruption of service without noticeable discernment;
preemptively handing off a caller or data user to a new tower 208 or wireless network access point 206 to free up capacity within a coverage area that is about to be over-utilized;
caching data at a wireless network access point 206 in response to the prediction of the occurrence of an overutilization event, such as when there is a constraint between the wireless network access point 206 and its main transmission trunk.

In order to perform these preemptive Qos operations a wireless service provider monitors network activity to determine whether bandwidth constraints are occurring or are anticipated to occur. In various embodiments, as described in greater detail herein, the wireless service provider receives bandwidth consumption projections from a wireless bandwidth QoS management system 150 implemented on a mobile device 204. In these and other embodiments, the wireless service provider uses the bandwidth consumption projections to anticipate bandwidth constraints.

In these various embodiments, the wireless service provider issues bandwidth consumption mitigation requests to predetermined mobile devices 204 if a current or potential bandwidth constraint has been detected. In various embodiments, the mitigation request is provided to the user 202 of a mobile device 204. In certain embodiments, the mitigation request is provided to a plurality of users 202 of a corresponding plurality of mobile devices 204. In various embodiments, compliance with the mitigation request may be at the discretion of the user 202 or compulsory.

In one embodiment, the mitigation request comprises making an offer for the user 202 to reduce bandwidth consumption at a predetermined point in time in exchange for improved service at some other predetermined point in time. For example, a user 202 watching a movie on a tablet device may be shown a message such as: “Warning: Network bandwidth is constrained. If you continue, you may suffer decreased bandwidth and your video may pause frequently. If you agree to suspend playback of this movie for ‘x’ minutes, higher quality of service will be provided in ‘y’ minutes.”

In various embodiments, compliance with a mitigation request is compulsory, according to predetermined policy. As an example, the wireless service agreement for the user 202 may require compulsory mitigation of bandwidth consumption under predetermined circumstances, such as peak load times. In one embodiment, the mitigation request comprises compulsory policy changes that may be implemented for recurring, scheduled operations. For example, if a user 202 performs data replication on a prescribed schedule, such as with email or social networks, the frequency of such replications may be modified. To further the example, instead of replicating email once every eight minutes and updating social network status every thirty minutes, email policy may be changed to once every twelve minutes and social network status to once every sixty minutes.

In another embodiment, the mitigation request comprises compulsory modification of application behavior according to the amount of buffered content data. For example, certain mobile devices 204 may have buffers that can be filled to eliminate gaps in playback. To further the example, a predetermined mobile device 204 may have a half-full buffer containing multiple seconds of content. The service provider may cap the buffer at this level, such that the retrieved content does not exceed what is needed by the user 202. As a result, the bandwidth requirements of the mobile device 204 are reduced. In yet another embodiment, the mitigation request comprises compulsory modification of application behavior according to a user's 202 class of wireless service. As an example, certain users 202 may pay more for higher classes of service, and thus not be subject to constraints. Others may subscribe to less expensive data plans, and as a result, be subjected to more significant cuts in bandwidth consumed.

Once the bandwidth mitigation requests are issued, the wireless service provider assesses the effect of their responses from individual users 202 and mobile devices 204. In various embodiments, the wireless service provider maintains records of recent mitigation requests. In certain of these embodiments, tiers of actions may be taken in the event that voluntary compliance was not sufficient. In these embodiments, the wireless service provider monitors system utilization to ascertain whether a bandwidth constraint condition still exists or may be imminent.

In various embodiments, additional bandwidth mitigation requests are issued if the results from the original set of mitigation requests are insufficient to maintain bandwidth availability. For example, if previously-made bandwidth mitigation requests for voluntary compliance prove to be insufficient, then compulsory mitigation requests may need to be issued. Likewise if previously-issued bandwidth mitigation requests only addressed certain classes of users 202 or applications, then mitigation requests may need to be issued to additional classes of users 202 or applications.

From the foregoing, it will be appreciated that implementation of the invention allows wireless network service providers to save infrastructure costs by implementing smart system commands, rather than build out new capacity. It will likewise be appreciated that the novelty of the invention is applicable to any form of radio frequency network providing bilateral exchange of data. For example, the past decade has seen various radio frequency technologies introduced to improve data performance (e.g., 3GPP Long Term Evolution (LTE), WiMAX, etc.), and it is likely that future data networks may either overlay a voice network or exist separately. By extension, the novelty of the invention provides wireless service providers more options, today and in the future, for achieving customer satisfaction while minimizing their capital expenditure (CAPEX) costs.

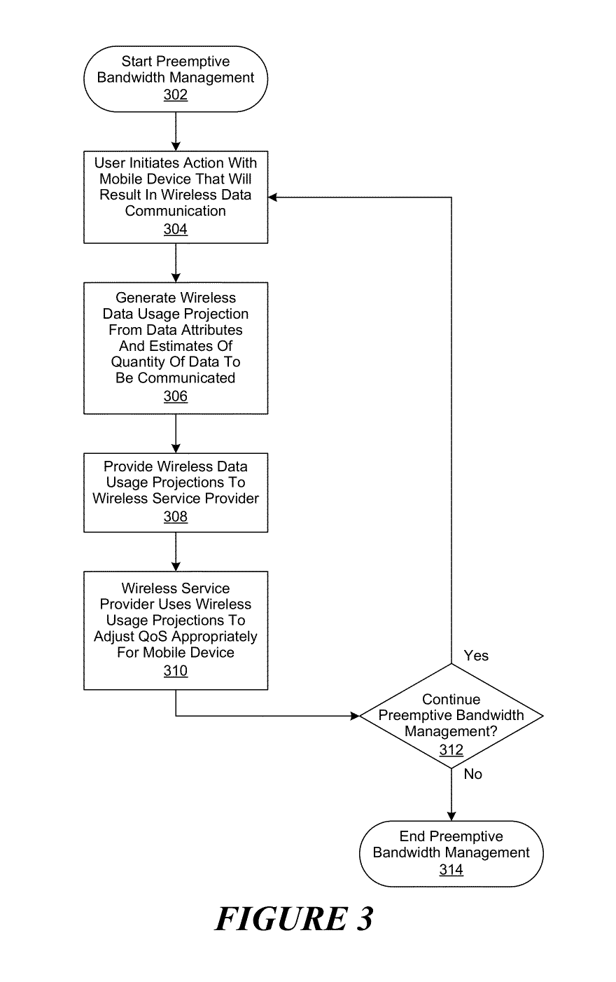

FIG. 3 is a generalized flowchart of preemptive wireless bandwidth management operations as implemented in accordance with an embodiment of the invention. In this embodiment, preemptive wireless bandwidth management operations are begun in step 302, followed by a user initiating an action related to wirelessly communicating data with a mobile device in step 304. Then, in step 306, a wireless bandwidth Quality of Service (QoS) management system implemented on the mobile device generates a bandwidth consumption projection, based upon attributes (e.g., voice, text, video, etc.) of the data communication activity and an estimate of how much data will be wirelessly communicated.

The bandwidth consumption projections are then provided to the wireless service provider in step 308, who then uses the provided bandwidth consumption projections in step 310 to adjust wireless bandwidth QoS appropriately for the wireless device. A determination is then made in step 312 whether to continue preemptive wireless bandwidth management operations. If so, then the process is continued, proceeding with step 302. Otherwise, preemptive wireless bandwidth management operations are ended in step 314.

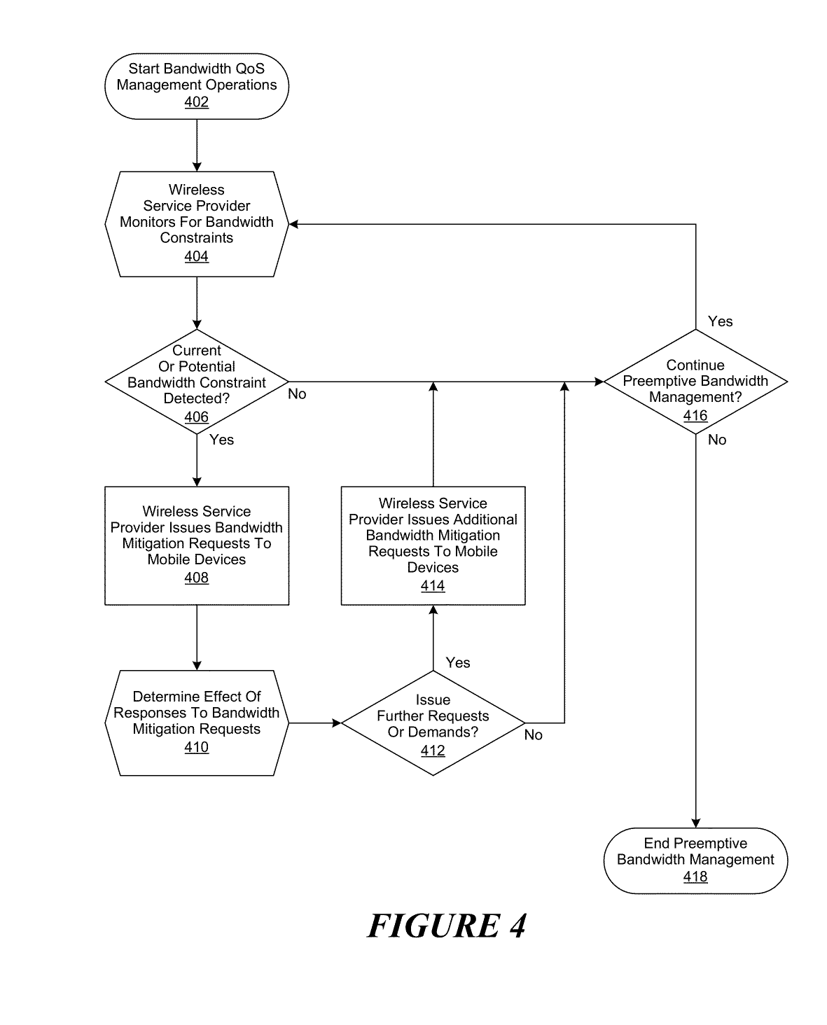

FIG. 4 is a generalized flowchart of wireless bandwidth Quality-of-Service (QoS) management operations as implemented in accordance with an embodiment of the invention. In this embodiment, wireless bandwidth QoS management operations are begun in step 402, followed by a wireless service provider monitoring network bandwidth availability to determine whether bandwidth constraints are occurring or are anticipated to occur. A determination is then made in step 406 whether a current or potential bandwidth constraint has been detected. If not, then a determination is made in step 416 whether to continue wireless bandwidth QoS management operations. If so, then the process is continued, proceeding with step 404. Otherwise, wireless bandwidth QoS management operations are ended in step 418.

However, if it is determined in step 406 that a current or potential bandwidth constraint has been detected, then the wireless service provider issues bandwidth consumption mitigation requests in step 408 to predetermined mobile devices. Then, in step 410 the wireless service provider assesses the effect of the responses to the issued bandwidth mitigation requests. A determination is then made in step 412 whether to issue additional bandwidth mitigation requests. If not, then the process is continued, proceeding with step 416. Otherwise, the wireless service provider issues additional bandwidth mitigation requests to predetermined mobile devices in step 414 and the process is continued, proceeding with step 416.

Although the present invention has been described in detail, it should be understood that various changes, substitutions and alterations can be made hereto without departing from the spirit and scope of the invention as defined by the appended claims.

What is claimed is:

1. A computer-implemented method for preemptively managing bandwidth consumption in a wireless network, comprising:
receiving bandwidth availability data associated with a wireless network;
receiving bandwidth consumption projection data, the bandwidth consumption projection data corresponding to a first amount of bandwidth;
processing the network bandwidth availability data with the bandwidth consumption projection data to determine whether the wireless network can provide the first amount of bandwidth;
generating a bandwidth mitigation request when the wireless network environment is not able to provide the first amount of bandwidth;
providing the bandwidth mitigation request to a mobile device;
receiving an affirmative bandwidth mitigation request response from the mobile device; and
providing a second amount of bandwidth to the mobile device, the second amount of bandwidth being less than the first amount of bandwidth.

2. The method of claim 1, wherein the bandwidth consumption projection data is provided by the mobile device.

3. The method of claim 2, wherein the bandwidth consumption projection data is generated from at least one of the set of:
historical records of the duration of past wireless communication sessions;
attributes associated with data communicated during a wireless communication session;
historical records of streaming media consumption during past wireless communication sessions;
historical, average amount of data downloaded from a predetermined source;
external factors associated with data communicated during a predetermined wireless communication session;
historical bandwidth consumption in a static bandwidth consumption geographical area; and
historical bandwidth consumption in a dynamic bandwidth consumption geographical area.

4. The method of claim 1, wherein compliance with the bandwidth mitigation request comprises at least one of the set of:
discretionary compliance; and
compulsory compliance.

5. The method of claim 4, wherein the bandwidth mitigation request comprises at least one of the set of:
providing a discretionary offer to the user of the mobile device to reduce bandwidth consumption at a predetermined point in time in exchange for improved service at some other predetermined point in time;
implementing a compulsory change of policy for recurring, scheduled operations;
implementing a compulsory modification of application behavior according to the amount of content data stored in a buffer in the mobile device; and
implementing a compulsory modification of an application's behavior according to a user's class of wireless service.

6. The method of claim 1, wherein the bandwidth mitigation request is provided to the plurality of mobile devices.

7. A system comprising:
a processor;
a data bus coupled to the processor; and
a computer-usable medium embodying computer program code, the computer-usable medium being coupled to the data bus, the computer program code used for preemptively managing bandwidth consumption in a wireless network and comprising instructions executable by the processor and configured for:
receiving bandwidth availability data associated with a wireless network;
receiving bandwidth consumption projection data, the bandwidth consumption projection data corresponding to a first amount of bandwidth;
processing the network bandwidth availability data with the bandwidth consumption projection data to determine whether the wireless network can provide the first amount of bandwidth;
generating a bandwidth mitigation request when the wireless network environment is not able to provide the first amount of bandwidth;
providing the bandwidth mitigation request to a mobile device;
receiving an affirmative bandwidth mitigation request response from the mobile device; and
providing a second amount of bandwidth to the mobile device, the second amount of bandwidth being less than the first amount of bandwidth.

8. The system of claim 7, wherein the bandwidth consumption projection data is provided by the mobile device.

9. The system of claim 8, wherein the bandwidth consumption projection data is generated from at least one of the set of:
historical records of the duration of past wireless communication sessions;
attributes associated with data communicated during a wireless communication session;
historical records of streaming media consumption during past wireless communication sessions;
historical, average amount of data downloaded from a predetermined source;
external factors associated with data communicated during a predetermined wireless communication session;
historical bandwidth consumption in a static bandwidth consumption geographical area; and
historical bandwidth consumption in a dynamic bandwidth consumption geographical area.

10. The system of claim 7, wherein compliance with the bandwidth mitigation request comprises at least one of the set of:
discretionary compliance; and
compulsory compliance.

11. The system of claim 10, wherein the bandwidth mitigation request comprises at least one of the set of:
providing a discretionary offer to the user of the mobile device to reduce bandwidth consumption at a predetermined point in time in exchange for improved service at some other predetermined point in time;
implementing a compulsory change of policy for recurring, scheduled operations;
implementing a compulsory modification of application behavior according to the amount of content data stored in a buffer in the mobile device; and
implementing a compulsory modification of an application's behavior according to a user's class of wireless service.

12. The system of claim 7, wherein the bandwidth mitigation request is provided to the plurality of mobile devices.

13. A non-transitory, computer-readable storage medium embodying computer program code, the computer program code comprising computer executable instructions configured for:
receiving bandwidth availability data associated with a wireless network;
receiving bandwidth consumption projection data, the bandwidth consumption projection data corresponding to a first amount of bandwidth;
processing the network bandwidth availability data with the bandwidth consumption projection data to determine whether the wireless network can provide the first amount of bandwidth;
generating a bandwidth mitigation request when the wireless network environment is not able to provide the first amount of bandwidth;
providing the bandwidth mitigation request to a mobile device;
receiving an affirmative bandwidth mitigation request response from the mobile device; and
providing a second amount of bandwidth to the mobile device, the second amount of bandwidth being less than the first amount of bandwidth.

14. The non-transitory, computer-readable storage medium of claim 13, wherein the bandwidth consumption projection data is provided by the mobile device.

15. The non-transitory, computer-readable storage medium of claim 14, wherein the bandwidth consumption projection data is generated from at least one of the set of.
historical records of the duration of past wireless communication sessions;
attributes associated with data communicated during a wireless communication session;
historical records of streaming media consumption during past wireless communication sessions;
historical, average amount of data downloaded from a predetermined source;
external factors associated with data communicated during a predetermined wireless communication session;
historical bandwidth consumption in a static bandwidth consumption geographical area; and
historical bandwidth consumption in a dynamic bandwidth consumption geographical area.

16. The non-transitory, computer-readable storage medium of claim 13, wherein compliance with the bandwidth mitigation request comprises at least one of the set of:
discretionary compliance; and
compulsory compliance.

17. The non-transitory, computer-readable storage medium of claim 16, wherein the bandwidth mitigation request comprises at least one of the set of:
providing a discretionary offer to the user of the mobile device to reduce bandwidth consumption at a predetermined point in time in exchange for improved service at some other predetermined point in time;
implementing a compulsory change of policy for recurring, scheduled operations;
implementing a compulsory modification of application behavior according to the amount of content data stored in a buffer in the mobile device; and
implementing a compulsory modification of an application's behavior according to a user's class of wireless service.

18. The non-transitory, computer-readable storage medium of claim 13, wherein the bandwidth mitigation request is provided to the plurality of mobile devices.

19. The non-transitory, computer-readable storage medium of claim 13, wherein the computer executable instructions are deployable to a client system from a server system at a remote location.

20. The non-transitory, computer-readable storage medium of claim 13, wherein the computer executable instructions are provided by a service provider to a user on an on-demand basis.
